(19) United States
(12) Patent Application Publication
(10) Pub. No.: US 2025/0321387 A1
(43) Pub. Date: Oct. 16, 2025

(54) OPTICAL MODULE WITH DETACHABLE PULL TAB

(71) Applicant: Global Technology Inc., Ningbo (CN)

(72) Inventors: Taotao YE, Ningbo (CN); Qilin HONG, Ningbo (CN); Kejun CHEN, Ningbo (CN)

(21) Appl. No.: 18/761,969

(22) Filed: Jul. 2, 2024

(30) Foreign Application Priority Data
Apr. 12, 2024 (CN) 202410444044.7

(51) Int. Cl. G02B 6/38

(52) U.S. Cl. CPC G02B 6/3893; G02B 6/387

(57) ABSTRACT

The present disclosure provides an optical module, configured to be inserted into a cage in a pluggable manner. The optical module includes a housing and a release mechanism. The release mechanism includes an engagement component and a pull tab. The engagement component is movably disposed on the housing and configured to be detachably engaged with the cage, and the pull tab is pivotally connected to the engagement component. The engagement component has a mounting recess, and the mounting recess includes a mounting portion and a tapered opening connected to each other. The tapered opening tapers toward the mounting portion, and the pull tab is detachably disposed in the mounting portion through the tapered opening.

### CROSS-REFERENCE TO RELATED APPLICATIONS

This non-provisional application claims priority under 35 U.S.C. § 119(a) on Patent Application No(s). 202410444044.7 filed in China on Apr. 12, 2024, the entire contents of which are hereby incorporated by reference.

### BACKGROUND

### Technical Field

The present disclosure relates to an optical module, particularly to an optical module including a release mechanism.

### Related Art

Optical modules can transmit and/or receive optical signals for various applications including, but not limited to, internet data center, Cable TV, and fiber to the home (FTTH). Using optical modules for transmission can provide higher transmission rates and signal bandwidth over longer transmission distances. In order to enhance the compatibility of optical internetworking products all over the world and to reduce the burden of maintenance, organizations such as Multi-Source Agreement (MSA), Institute of Electrical and Electronic Engineers (IEEE), and Optical Internetworking Forum (OIF) have developed several form factors adapted to different signal transmission rates. These form factors include, but not limited to, XFP, SFP, QSFP (Quad Small Form Factor Pluggable), QSFP-DD (Double Density), OSFP (Octal Small Form Factor Pluggable), CPO (Co-Packaged Optics), and OSFP-XD (OCTAL SMALL FORM FACTOR eXtra Dense PLUGGABLE).

However, conventional optical modules still present some problems, such as optical efficiency (power), space management, thermal management, insertion loss and manufacturing yield.

### SUMMARY

According to one aspect of the present disclosure, an optical module is configured to be inserted into a cage in a pluggable manner. The optical module includes a housing and a release mechanism. The release mechanism includes an engagement component and a pull tab. The engagement component is movably disposed on the housing and configured to be detachably engaged with the cage, and the pull tab is pivotally connected to the engagement component. The engagement component has a mounting recess, and the mounting recess includes a mounting portion and a tapered opening connected to each other. The tapered opening tapers toward the mounting portion, and the pull tab is detachably disposed in the mounting portion through the tapered opening.

According to another aspect of the present disclosure, an optical module is configured to be inserted into a cage in a pluggable manner. The optical module includes a housing and a release mechanism. The release mechanism includes an engagement component and a pull tab. The engagement component is movably disposed on the housing and configured to be detachably engaged with cage. The pull tab has a groove, and the engagement component has a mounting recess. The mounting recess is located in the groove. The mounting recess includes a mounting portion and a tapered opening connected to each other. The tapered opening tapers toward the mounting portion, and the pull tab is detachably disposed in the mounting portion through the tapered openings.

According to still another aspect of the present disclosure, an optical module is configured to be inserted into a cage in a pluggable manner. The optical module includes a housing and a release mechanism. The release mechanism includes an engagement component and a pull tab. The engagement component is movably disposed on the housing and configured to be detachably engaged with the cage. The engagement component has a mounting recess proximate to an inner side wall of the pull tab opposite to an outer side wall of the pull tab. The mounting recess includes a mounting portion and a tapered opening connected to each other. The tapered opening tapers toward the mounting portion, and the pull tab is detachably disposed in the mounting portion through the tapered opening.

### BRIEF DESCRIPTION OF THE DRAWINGS

The present disclosure will become better understood from the detailed description given hereinbelow and the accompanying drawings which are given by way of illustration only and thus are not intended to limit the present disclosure and wherein:

FIG. 1 is an exploded view of an optical module and a cage according to one embodiment of the present disclosure;

FIG. 2 is an exploded view of the optical module in FIG. 1;

FIG. 3 is a partially enlarged view of the optical module in FIG. 2;

FIG. 4 is a partially enlarged side view of the optical module in FIG. 1;

FIG. 5 is an exploded view of the optical module in FIG. 4;

FIG. 6 is a perspective view of the optical module in FIG. 1 showing that a pull tab is in a horizontal state;

FIG. 7 is a partially enlarged cross-sectional view of the optical module in FIG. 6 showing that an engagement component is at an engagement position;

FIG. 8 is a side view of the optical module in FIG. 6 showing that the engagement component is at a releasing position;

FIG. 9 is a partially enlarged cross-sectional view of the optical module in FIG. 6 showing that an engagement component is at the releasing position;

FIG. 10 is a perspective view of the optical module in FIG. 6 showing that the pull tab is in an upright state; and

FIG. 11 is a partially enlarged side view of an optical module according to another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

In general, an optical module and a cage are firmly engaged with each other by a release mechanism disposed on the optical module. The engagement between the optical module and the cage may be released by the release mechanism when necessary, and then the optical module is allowed to be removed from the cage. A conventional release mechanism is provided with a user-friendly pull tab, and an engagement component of the pull tab for being engaged with the cage may be formed by injection molding. Since the pull tab is fixed with respect to the engagement component, the pull tab may obstruct the installation or removal of an optical fiber or a jumper into or from an optical port of the optical module. Also, the exposed pull tab is frequently touched or subjected to collisions, and thus may easily be dirty or damaged. However, the pull tab is not allowed to be replaced by a new one without the replacement of the entire release mechanism, which makes the replacement maintenance of the current release mechanism to be costly.

According to one embodiment of the present disclosure, an optical module is configured to be inserted into a cage in a pluggable manner. The optical module includes a housing and a release mechanism. The release mechanism includes an engagement component and a pull tab. The engagement component is movably disposed on the housing and configured to be detachably engaged with the cage. The pull tab is pivotally disposed on the engagement component. The engagement component has a mounting recess, and the mounting recess includes a mounting portion and a tapered opening connected to each other, a width of the tapered opening decreases from the mounting portion, and the pull tab is detachably disposed on the mounting portion through the tapered opening.

Some or all of the technical features disclosed in one or more embodiments of the present disclosure may be combined to achieve corresponding effects.

The term “couple” or “coupled to” refers to any connection, link, or the like. Moreover, the term “optically couple” or “optically coupled to” refers to a relationship where light is transmitted (imparted) from a device to another. Unless otherwise specified, devices that “couple” or “coupled to” each other do not need to be directly connected to each other and may be separated by intervening objects.

The term substantially, as generally referred to herein, refers to a degree of precision within acceptable tolerance that accounts for and reflects minor real-world variation due to material composition, material defects, and/or limitations/peculiarities in manufacturing processes. Such variation may therefore be said to achieve largely, but not necessarily wholly, the stated characteristic.

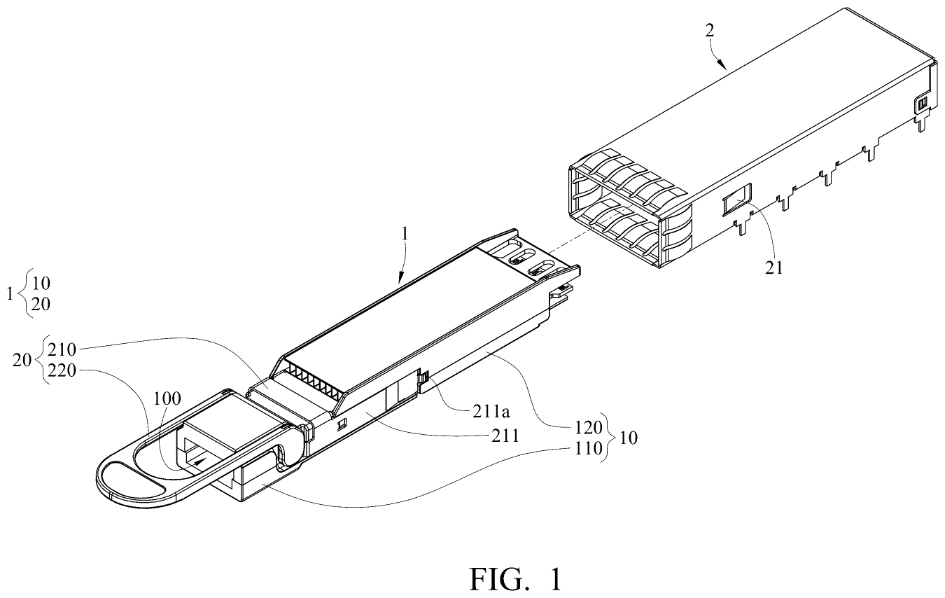

Please refer to FIG. 1. FIG. 1 is an exploded view of an optical module 1 and a cage 2 according to one embodiment of the present disclosure. In this embodiment, the optical module 1 may be inserted into a cage 2 in a pluggable manner. The optical module 1 may be understood as an optical transceiver, and the cage 2 may be understood as a metal cage of a motherboard installed in an ether network device.

The optical module 1 may include a housing 10 and a release mechanism 20. The housing 10 may be a housing made of metal. The housing 10 may be understood as an airtight encapsulation housing or a non-airtight encapsulation housing configured to encapsulate laser diodes. The housing 10 may include a head portion 110 and an insertion portion 120 connected to each other. The insertion portion 120 may be configured to be inserted into the cage 2. The head portion 110 may have an optical port 100. The optical port 100 may accommodate optical couplers such as an optical fiber connector or an active optical cable (AOC). In addition, the housing 10 may be a housing integrally formed as a single piece, or the housing 10 may be a multi-part housing including an upper housing part and a lower housing part. The housing 10 may accommodate a printed circuit board assembly (PCBA) and optical communication components disposed on the PCBA. For example, the optical communication components include, but not limited to, at least one of a transmitting optical sub-assembly (TOSA) and a receiver optical sub-assembly (ROSA).

The release mechanism 20 may include an engagement component 210 and a pull tab 220. The engagement component 210 may include an engagement arm 211, and the engagement arm 211 may be movably disposed on an outer side surface of the housing 10. The engagement component 210 in this embodiment may include two engagement arms 211 located on opposite sides of the housing 10, respectively. However, the specific configuration and shape of the engagement component 210 are not limited thereto. In some embodiments, the engagement component 210 may include single engagement arm 211. The engagement arm 211 of the engagement component 210 may include an engagement portion 211a corresponding to a slot on the cage 2. The engagement component 210 may be moved relative to the housing 10 so as to engage the engagement portion 211a with the slot on the cage 2. The pull tab 220 may be disposed on the engagement component 210.

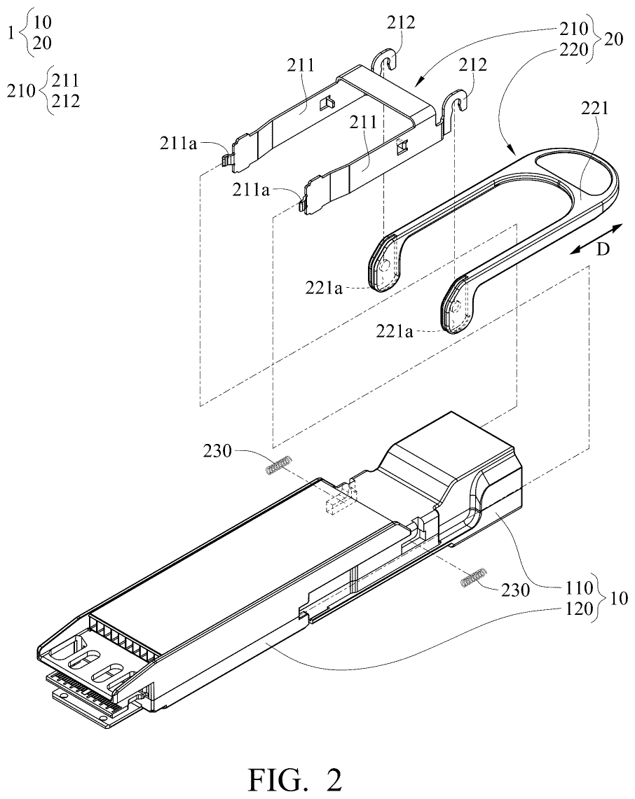

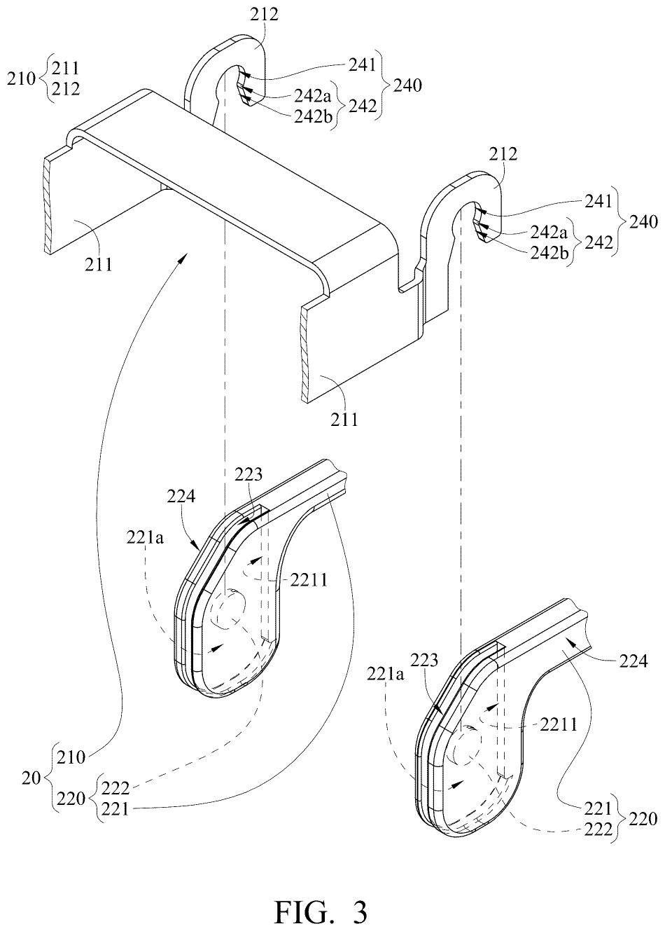

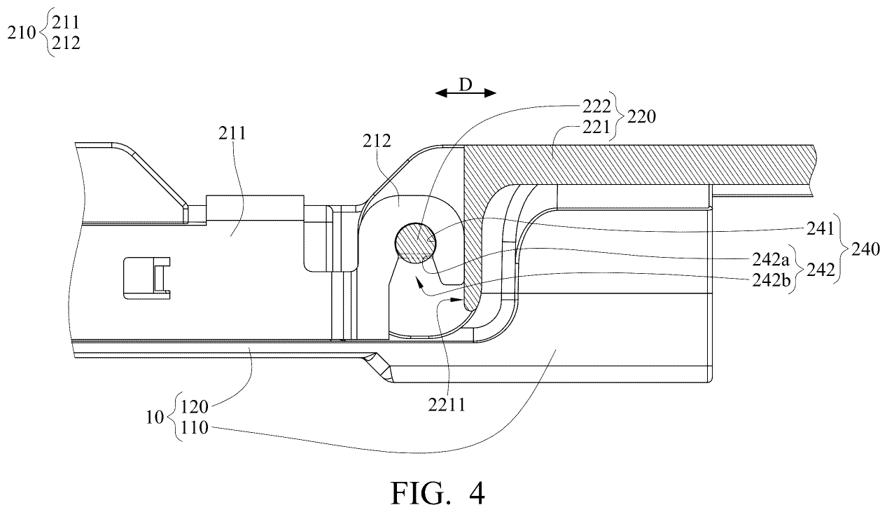

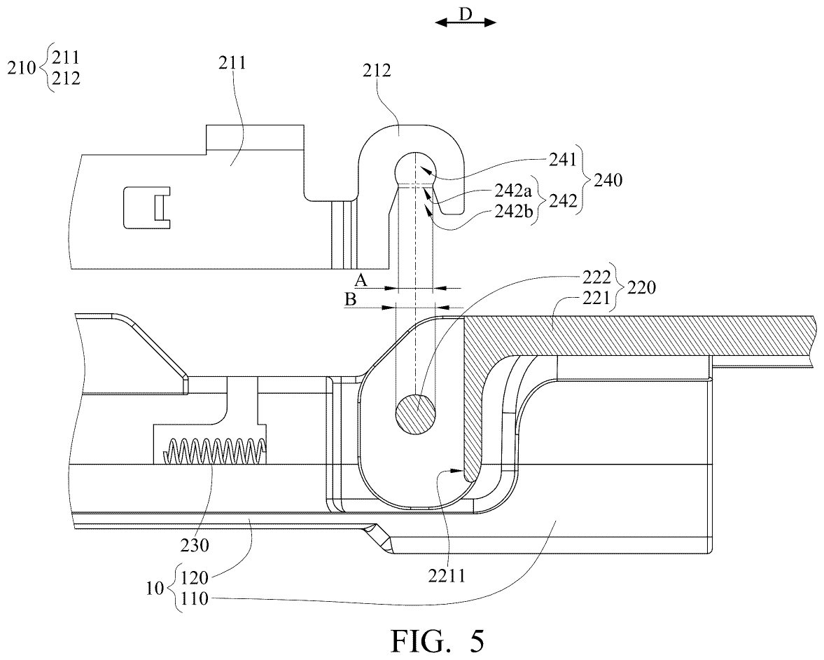

The pull tab 220 is disposed on the engagement component 210 in a detachable manner. Please refer to FIGS. 2 to 5. FIG. 2 is an exploded view of the optical module 1 in FIG. 1, FIG. 3 is a partially enlarged view of the optical module 1 in FIG. 2, FIG. 4 is a partially enlarged side view of the optical module 1 in FIG. 1, and FIG. 5 is an exploded view of the optical module 1 in FIG. 4. In order to make the present disclosure to be understood easily, a part of the pull tab 220 is omitted from FIGS. 4 and 5.

The release mechanism 20 may further include the same number of elastic components 230 as the engagement arms 211. The elastic component 230 is disposed on the housing 10 and constantly presses against the engagement component 210.

The engagement component 210 of the release mechanism 20 may have a mounting recess 240. As shown in FIGS. 4 and 5, the mounting recess 240 may include a mounting portion 241 and a tapered opening 242 connected to each other. The tapered opening 242 may taper toward the mounting portion 241. The pull tab 220 may be detachably disposed in the mounting portion 241 through the tapered opening 242. When the pull tab 220 is disposed in the mounting portion 241, the tapered opening 242 can limit the movement of the pull tab 220 to prevent the pull tab 220 from being detached therefrom.

According to one embodiment of the present disclosure, the pull tab 220 is pivotally connected to the engagement component 210. As shown in FIGS. 3 and 4, the pull tab 220 may include a main body 221 and a pivot 222 connected to the main body 221. An axial direction of the pivot 222 may substantially be perpendicular to a releasing direction D of the engagement component 210. The pivot 222 may be pivotally disposed in the mounting portion 241 through the tapered opening 242. In addition, the main body 221 of the pull tab 220 may have a groove 221a, and the mounting recess 240 of the engagement component 210 may be located in the groove 221a. Further, both of the pivot 222 and the mounting recess 240 may be located in the groove 221a. The groove 221a configured to accommodate the pivot 222 and the engagement component 210 allows the lateral thickness of the pull tab 220 to be reduced. Besides, the groove 221a can also cover the pivot 222 and at least a part of the mounting recess 240, thereby improving the appearance of the optical module 1.

According to one embodiment of the present disclosure, the pull tab 220 may have an inner side wall 223 and an outer side wall 224 opposite to each other. As shown in FIG. 3, the mounting recess 240 of the engagement component 210 and the inner side wall 223 may be located at the same side, such that the mounting recess 240 is proximate to the inner side wall 223. In one embodiment, the groove 221a of the pull tab 220 may have the inner side wall 223; that is, the inner side wall 223 may be a surface forming the groove 221a. The main body 221 of the pull tab 220 may have the outer side wall 224 which is outside the groove 221a.

According to one embodiment of the present disclosure, a size of the tapered opening 242 is changeable. As shown in FIGS. 4 and 5, at least a part of the engagement component 210 may be elastic to allow the tapered opening 242 to be widened. More specifically, the engagement component 210 may further include an elastic end portion 212 connected to the engagement arm 211. The engagement arm 211 is movably disposed on the housing 10, and the mounting recess 240 may be formed between the engagement arm 211 and the elastic end portion 212. The elastic end portion 212 may be bent by the user, or may be pushed by the pivot 222 of the pull tab 220 to be bent, thereby increasing a minimum width A of the tapered opening 242. When the minimum width A is larger than or equal to a radial dimension B (which may be understood as a diameter of the pivot 222 herein) of the pivot 222, the pivot 222 may be allowed to be disposed in the mounting portion 241 through the tapered opening 242. After the pivot 222 is pressed into the mounting portion 241, the minimum width A of the tapered opening 242 may restore, so that the minimum width A is smaller than the radial dimension B of the pivot 222, thereby ensuring that the pivot 222 is confined to be located in the mounting recess 240.

According to one embodiment of the present disclosure, the width of the tapered opening 242 may decrease first and then increase. As shown in FIG. 5, the tapered opening 242 may include a tapered section 242a and a widened section 242b connected to each other, and the tapered section 242a may be located between the mounting portion 241 and the widened section 242b. A width of the tapered section 242a may decrease from the mounting portion 241, and a width of the widened section 242b may increase from the tapered section 242a. Further, along a path from the mounting portion 241 to the widened section 242b, the width of the tapered section 242a may decrease to the minimum width A, and the width of the widened section 242b may increase from the minimum width A. The pull tab 220 may be detachably disposed in the mounting portion 241 through the widened section 242b and the tapered section 242a in sequence. The presence of the widened section 242b facilitates the pull tab 220 to be disposed on the engagement component 210.

FIG. 5 exemplarily illustrates that both of the edges of the tapered section 242a and the widened section 242b are flat. Therefore, the width of the tapered section 242a gradually decreases from the mounting portion 241, and the width of the widened section 242b gradually increases from the tapered section 242a. However, the present disclosure is not limited thereto. In some embodiments, the tapered section and the widened section may have a non-flat edge, such as a zigzag edge. Therefore, the width of the tapered section periodically decreases from the mounting portion, and the width of the widened section periodically increases from the tapered section.

For example, in a case where the form factor of the optical module meets, but not limited to, QSFP, QSFP-DD, or OSFP, in order to ensure both of the elasticity and the structural strength of the elastic end portion 212, both of the minimum width A of the tapered opening 242 and the radial dimension B of the pivot 222 may be limited. Further, the difference between the minimum width A of the tapered opening 242 and the radial dimension B (which may be understood as the diameter of the pivot 222 herein) of the pivot 222 may be greater than 0 mm. More specifically, the said difference meets the following inequality: 0 millimeter (mm)≤|A−B|. Therefore, the pivot 222 is ensured to be confined within the mounting portion 241 and is prevented from being detached therefrom. Further, when the said difference is less than 30% of the radial dimension B of the pivot 222, it may be ensured that the pivot 222 of the pull tab 220 is easily installed. In addition, the minimum width A of the tapered opening 242 and the radial dimension B of the pivot 222 may also meet the following inequality: 0.24 mm≤|A−B|≤0.44 mm. Therefore, the pivot 222 is prevented from being detached therefrom, the appropriate elasticity of the elastic end portion 212 facilitates the variation of the size of the tapered opening 242, and the overall structural strength of the elastic end portion 212 prevents the pull tab 220 from being detached from the mounting portion 241 due to unexpected pulling on the elastic end portion 212. The above listed end values are by way of example, and they may be adjusted according to actual needs.

The assembly of the pull tab 220 to the engagement component 210 will be described below. As shown in FIGS. 2 and 4, the engagement component 210 may be placed into the groove 221a of the pull tab 220. Next, as shown in FIG. 4, the pull tab 220 or the engagement component 210 is moved appropriately so that the pivot 222 of the engagement component 210 is moved into the mounting recess 240. The pivot 222 is disposed in the mounting portion 241 through the tapered opening 242. Since the pull tab 220 is disposed on the engagement component 210 in a detachable and pivotable manner, the engagement component 210 and the pull tab 220 can be two separate components. The dirty or damaged pull tab 220 can be replaced without moving or detaching the engagement component 210, and thus the cost of the maintenance of the release mechanism 20 is reduced and the maintenance of the release mechanism 20 is simplified. In order to reduce the cost of maintenance, the pull tab 220 may be made of plastic material. In order to ensure elasticity and prolong the lifespan, the engagement component 210 may be made of metal material.

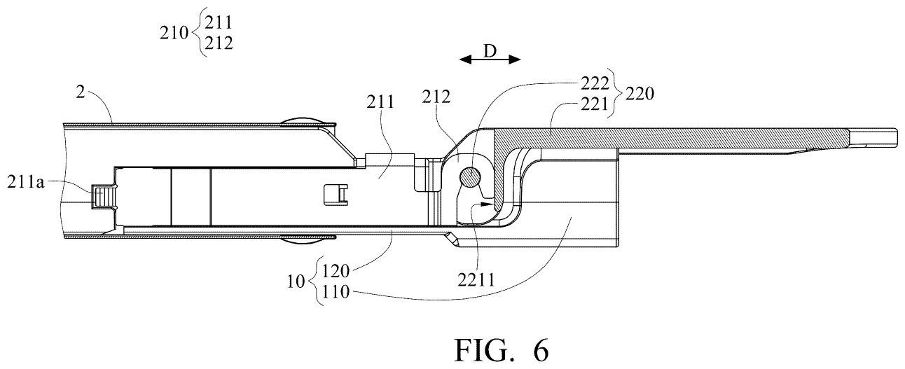

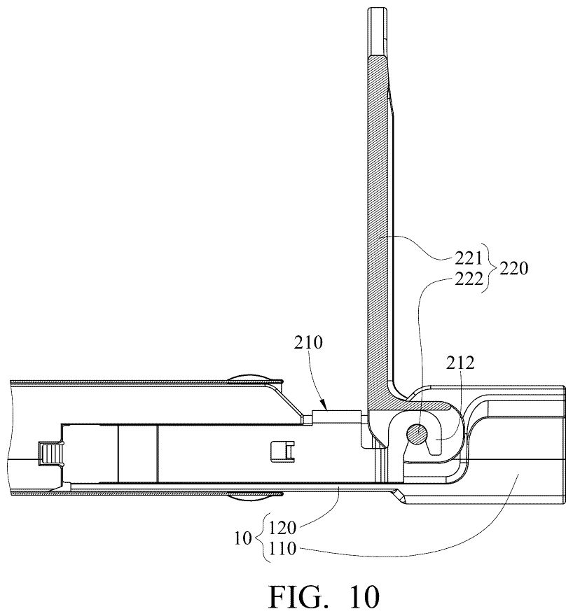

The pull tab 220 may be pivoted upward to prevent the pull tab 220 from obstructing the installation or removal of the optical fiber connector into or from the optical port 100 of the housing 10. Please refer to FIG. 6 and FIG. 10 together. FIG. 6 is a perspective view of the optical module 1 in FIG. 1 showing that the pull tab 220 is in a horizontal state, and FIG. 10 is a perspective view of the optical module 1 in FIG. 6 showing that the pull tab 220 is in an upright state. As shown in FIG. 6, when the pull tab 220 is in the horizontal state, the pull tab 220 can protect an optical coupler, such as an optical fiber connector not shown in the drawings, from dust pollution. In addition, the pull tab 220 in the horizontal state can be pulled so as to remove the optical module 1 from the cage 2. For example, a user may hold the main body 221 of the pull tab 220 and pull the main body 221 along the releasing direction D. In this embodiment, the engagement component 210 may rest on a side wall 2211 of the groove 221a so as to keep the pull tab 220 in the horizontal state.

The pull tab 220 may be pivoted relative to the engagement component 210 by an angle, such as 90 degrees, to be changed from the horizontal state to an upright state. As shown in FIG. 10, when the pull tab 220 is in the upright state, the optical fiber connector may be plugged into or removed from the optical port 100 of the housing 10. In this embodiment, the main body 221 may rest on the engagement component 210 so as to keep the pull tab 220 in the upright state, thereby allowing the pull tab 220 to be supported without hand or external force during the installation or removal of optical fiber connector.

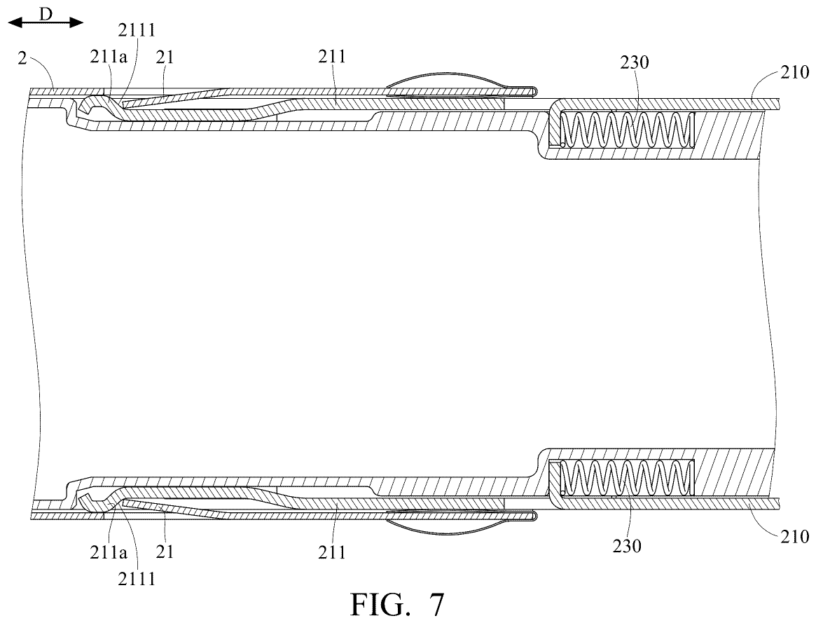

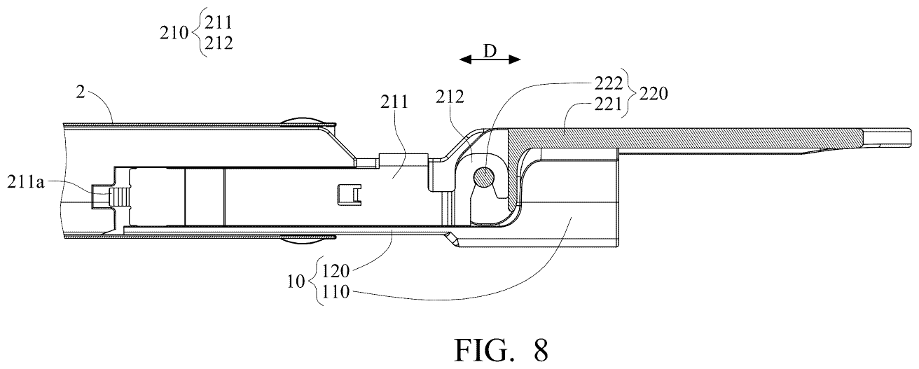

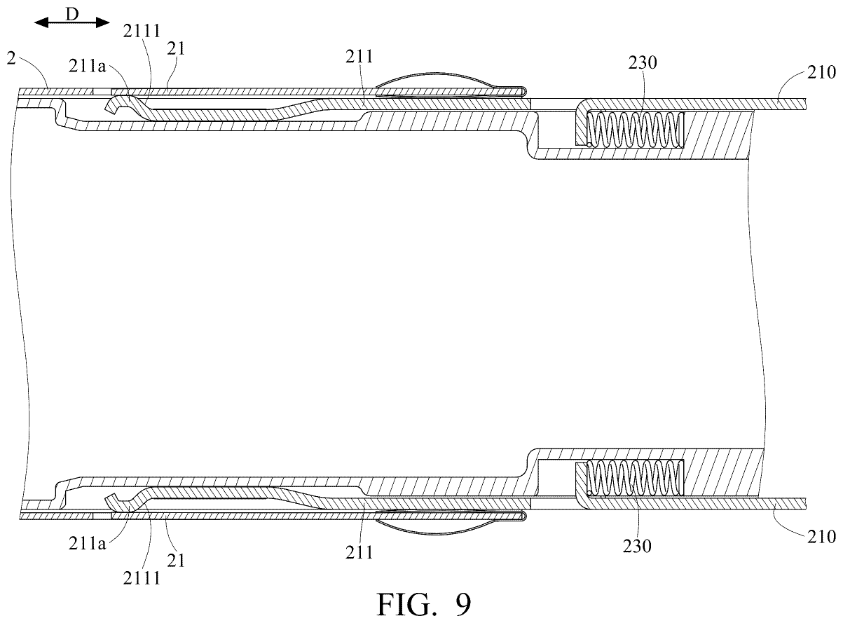

Please refer to FIGS. 7 to 9. FIG. 7 is a partially enlarged cross-sectional view of the optical module 1 in FIG. 6 showing that the engagement component 210 is at an engagement position, FIG. 8 is a side view of the optical module 1 in FIG. 6 showing that the engagement component 210 is at a releasing position, and FIG. 9 is a partially enlarged cross-sectional view of the optical module 1 in FIG. 6 showing that the engagement component 210 is at the releasing position.

The engagement component 210 may be moved between an engagement position (as shown in FIG. 7) and a releasing position (as shown in FIG. 9) relative to the housing 10 along a releasing direction D. As shown in FIG. 7, the elastic component 230 may press against the engagement component 210 so as to keep the engagement component 210 at the engagement position, and thus the engagement portion 211a is stably engaged with the cage 2. Therefore, the optical module 1 can be firmly inserted into the cage 2. In one embodiment, the engagement portion 211a may be interlocked with the cage 2. In one embodiment, the engagement portion 211a may be fitted into a slot of the cage 2.

As shown in FIG. 1 and FIGS. 7 to 9, a user may move the engagement component 210 relative to the housing 10 along the releasing direction D by pulling the pull tab 220. The engagement portion 211a may push a flexible arm 21 of the cage 2 so that the engagement portion 211a slides by an inclined surface 2111 thereof. The engagement portion 211a may bend the flexible arm 21 so as to move the engagement component 210 to the releasing position. When the pull tab 220 is further pulled along the releasing direction D, the insertion portion 120 of the housing 10 may be removed from the cage 2.

Furthermore, when the engagement component 210 is at the releasing position, the elastic component 230 may be compressed. When the user releases the pull tab 220, the elastic potential energy stored in the elastic component 230 may be released to restore the engagement component 210 back to the engagement position.

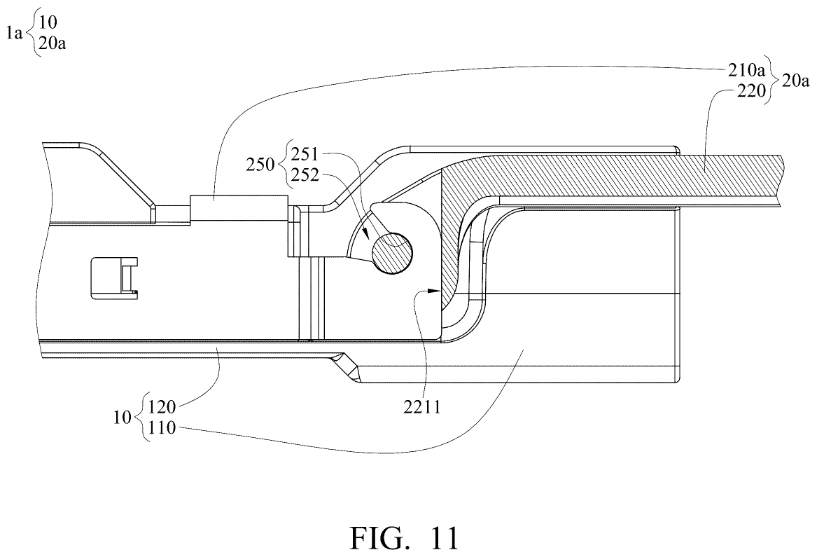

In addition, in FIG. 4, the mounting recess 240 of the engagement component 210 includes a tapered opening 242, where a surface where the tapered opening 242 is located has a normal direction toward a bottom side in the drawing, but the specific configuration and shape of the engagement component 210 are not limited to such aspect. FIG. 11 is a partially enlarged side view of an optical module la according to another embodiment of the present disclosure. In this embodiment, the optical module 1a may include a release mechanism 20a, and the release mechanism 20a may include an engagement component 210a and a pull tab 220. Because the specific description related to the pull tab 220 may correspond to the aforesaid contents in FIGS. 1 to 5, it will be omitted from the below description.

The engagement component 210a may have a mounting recess 250, and the mounting recess 250 may include a mounting portion 251 and a tapered opening 252 connected to each other. A surface where the tapered opening 252 is located may have a direction toward the top left side in the drawing. The pull tab 220 may be detachably disposed in the mounting portion 251 through the tapered opening 252. In other embodiments, the surface where the tapered opening 252 is located may have a direction toward any side in the drawing.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An optical module, configured to be inserted into a cage in a pluggable manner, the optical module comprising:
a housing; and
a release mechanism, comprising:
an engagement component, movably disposed on the housing and configured to be detachably engaged with the cage; and
a pull tab, pivotally connected to the engagement component;
wherein, the engagement component has a mounting recess, the mounting recess comprises a mounting portion and a tapered opening connected to each other, the tapered opening tapers toward the mounting portion, and the pull tab is detachably disposed in the mounting portion through the tapered opening.

2. The optical module according to claim 1, wherein at least a part of the engagement component is elastic to allow the tapered opening to be widened.

3. The optical module according to claim 1, wherein the engagement component comprises an engagement arm and an elastic end portion connected to each other, the engagement arm is movably disposed on the housing, and the mounting recess is located between the engagement arm and the elastic end portion.

4. The optical module according to claim 1, wherein the tapered opening comprises a tapered section and a widened section connected to each other, the tapered section is located between the mounting portion and the widened section, a width of the tapered section decreases from the mounting portion, a width of the widened section increases from the tapered section, and the pull tab is detachably disposed in the mounting portion through the widened section and the tapered section in sequence.

5. The optical module according to claim 1, wherein the pull tab comprises a main body and a pivot connected to the main body, and the pivot is pivotally disposed on the mounting portion through the tapered opening.

6. The optical module according to claim 5, wherein the main body of the pull tab has a groove, and both of the pivot and the mounting recess of the engagement component are located in the groove,
the pull tab is pivotable between a horizontal state and an upright state relative to the engagement component, the engagement component rests on a side wall of the groove so as to keep the pull tab in the horizontal state, and the main body rests on the engagement component so as to keep the pull tab in the upright state.

7. An optical module, configured to be inserted into a cage in a pluggable manner, the optical module comprising:
a housing; and
a release mechanism, comprising:
an engagement component, movably disposed on the housing and configured to be detachably engaged with the cage; and
a pull tab;
wherein, the pull tab has a groove, the engagement component has a mounting recess, the mounting recess is located in the groove, the mounting recess comprises a mounting portion and a tapered opening connected to each other, the tapered opening tapers toward the mounting portion, and the pull tab is detachably disposed in the mounting portion through the tapered opening.

8. The optical module according to claim 7, wherein at least a part of the engagement component is elastic to allow the tapered opening to be widened.

9. The optical module according to claim 7, wherein the engagement component comprises an engagement arm and an elastic end portion connected to each other, the engagement arm is configured to be detachably engaged with the cage, and the mounting recess is formed between the engagement arm and the elastic end portion.

10. The optical module according to claim 7, wherein the tapered opening comprises a tapered section and a widened section connected to each other, the tapered section is located between the mounting portion and the widened section, a width of the tapered section decreases from the mounting portion, a width of the widened section increases from the tapered section, and the pull tab is detachably disposed in the mounting portion through the widened section and the tapered section in sequence.

11. The optical module according to claim 7, wherein the pull tab comprises a main body having the groove and a pivot connected to the main body, both of the pivot and the mounting recess are located in the groove, and the pivot is pivotally disposed on the mounting portion through the tapered opening.

12. An optical module, configured to be inserted into a cage in a pluggable manner, the optical module comprising:
a housing; and
a release mechanism, comprising:
an engagement component, movably disposed on the housing and configured to be detachably engaged with the cage; and
a pull tab;
wherein the engagement component has a mounting recess proximate to an inner side wall of the pull tab opposite to an outer side wall of the pull tab, the mounting recess comprises a mounting portion and a tapered opening connected to each other, the tapered opening tapers toward the mounting portion, and the pull tab is detachably disposed in the mounting portion through the tapered opening.

13. The optical module according to claim 12, wherein at least a part of the engagement component is elastic to allow the tapered opening to be widened.

14. The optical module according to claim 12, wherein the engagement component comprises an engagement arm and an elastic end portion connected to each other, the engagement arm is configured to be detachably engaged with the cage, and the mounting recess is formed between the engagement arm and the elastic end portion.

15. The optical module according to claim 12, wherein the tapered opening comprises a tapered section and a widened section connected to each other, the tapered section is located between the mounting portion and the widened section, a width of the tapered section decreases from the mounting portion, a width of the widened section increases from the tapered section, and the pull tab is detachably disposed in the mounting portion through the widened section and the tapered section in sequence.

16. The optical module according to claim 12, wherein the pull tab comprises a main body and a pivot connected to the main body, the main body has a groove having the inner side wall, the main body has the outer side wall outside the groove, both of the pivot and the mounting recess are located in the groove, and the pivot is pivotally disposed on the mounting portion through the tapered opening.
